(19) United States
(12) Patent Application Publication
(10) Pub. No.: US 2009/0133343 A1
(43) Pub. Date: May 28, 2009

(54) Formed-In-Place Wall Structure and Associated Methods

(75) Inventor: Randall G. Tedder, Summerfield, FL (US)

Correspondence Address: Michael J. Colitz, III;Holland & Knight LLP, P.O. Box 1288, Tampa, FL, 33601-1288, US

(73) Assignee: RANDALL G. TEDDER CONSTRUCTION, INC., Ocala, FL (US)

(21) Appl. No.: 12/130,163

(22) Filed: May 30, 2008

Related U.S. Application Data
(60) Provisional application No. 60/940,772, filed on May 30, 2007.

(51) Int. Cl. E06B 1/24; E04B 2/68

(52) U.S. Cl. 52/204.1; 52/745.09; 52/408; 52/745.15

(57) ABSTRACT

A system and method for forming wall structures onsite without the need for prefabricated wall elements are provided. The wall structures can be constructed with the use of only a framing crew, without the need for other types of construction specialists. Further, the wall structures can be assembled very quickly. The wall structure includes a wood frame, with styrofoam interior, and concrete blown onto the outer surface thereof.

### CROSS-REFERENCE TO RELATED APPLICATION

This application claims priority to provisional application Ser. No. 60/940,772, filed May 30, 2007.

### BACKGROUND OF THE INVENTION

1. Field of the Invention

The present invention relates to systems and methods for building construction, and, more particularly, to such systems and methods for erecting wall structures in place.

2. Description of Related Art

It is known to construct walls onsite with the use of prefabricated materials, such as concrete blocks and prefabricated concrete columns and other structures. However, both of these methods require the transport of heavy materials, and the employment of specialized work crews to assemble the concrete materials onsite.

Therefore, it would be beneficial to provide a system and method for constructing wall structures onsite using concrete without the need for prefabrication off-site, or for pouring and lifting poured concrete elements.

### SUMMARY OF THE INVENTION

The present invention is directed to a system and method for forming wall structures onsite without the need for prefabricated wall elements. The wall structures can be constructed with the use of only a framing crew, without the need for other types of construction specialists. Further, the wall structures can be assembled very quickly.

The features that characterize the invention, both as to organization and method of operation, together with further objects and advantages thereof, will be better understood from the following description used in conjunction with the accompanying drawing. It is to be expressly understood that the drawing is for the purpose of illustration and description and is not intended as a definition of the limits of the invention. These and other objects attained, and advantages offered, by the present invention will become more fully apparent as the description that now follows is read in conjunction with the accompanying drawing.

### BRIEF DESCRIPTION OF THE DRAWINGS

FIG. 1 is a front view of a wall structure of initial elements of the present invention, including plywood base and frame.

FIG. 2 is a front view of a partially assembled wall structure of the present invention with styrofoam insulation laid in the frame.

FIGS. 3 and 4 are front (FIG. 3) and horizontal cross-sectional (FIG. 4) views of the wall structure following an application of concrete.

FIGS. 5 and 6 are vertical cross-sectional views of the wall structure before (FIG. 5) and after (FIG. 6) an application of concrete.

FIG. 7 is a front cross-sectional view of a wall structure including a lintel.

FIG. 8 is a horizontal cross-sectional view of a wall structure at a corner.

FIGS. 9A,9B is a flowchart for an exemplary embodiment of the present invention.

### DETAILED DESCRIPTION OF THE PREFERRED EMBODIMENTS

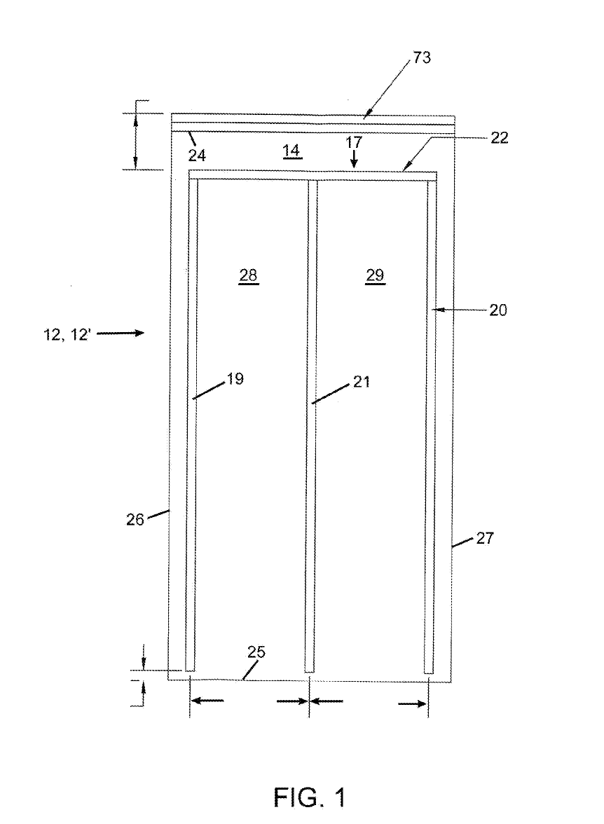

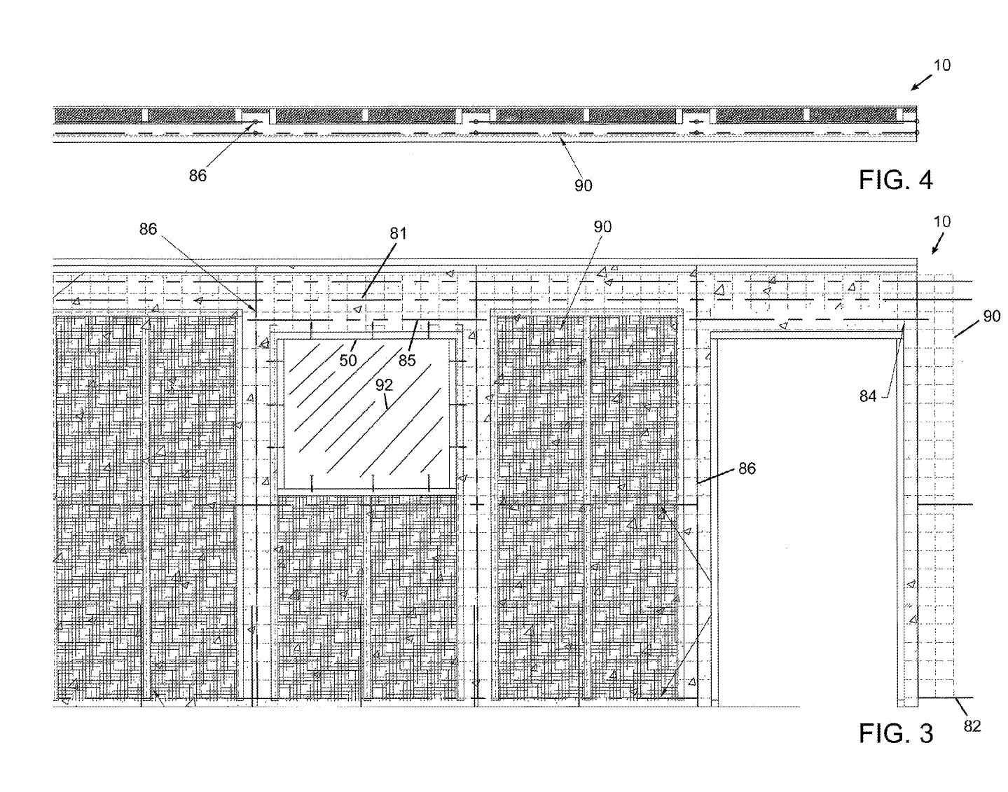

A description of the preferred embodiments of the present invention will now be presented with reference to FIGS. 1-9.

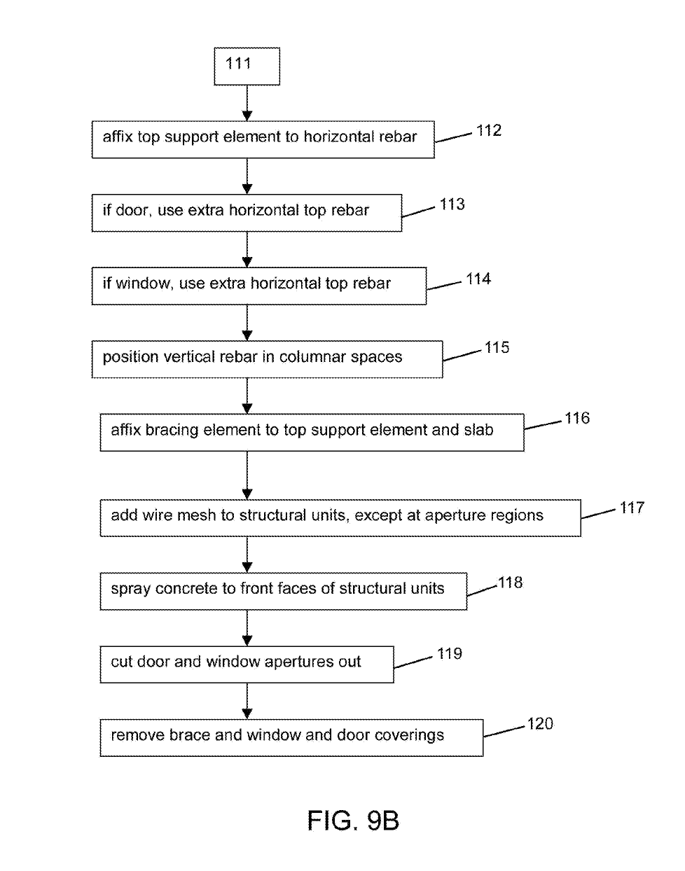

The front view of FIG. 1 illustrates the initial structure of the wall assembly and process of the present invention. The system 10 (FIGS. 1-8) and method 100 (FIGS. 9A,9B) start with a concrete horizontal foundation slab 11 having been poured onsite. To form a solid wall unit 12,12′, a structural, substantially planar construction element, such as a base sheet 14 of plywood, has a moisture-barrier layer 15, such as Visqueen, although this is not intended as a limitation, affixed to a rear face 16 thereof (block 101). The base sheet 14 has a frame 17 affixed to a front face 18 thereof (block 102). The frame 17 can comprise three substantially parallel elongated wooden elements 19-21 positioned in vertical spaced-apart relation from each other. The vertical frame elements 19-21 are bridged by a top elongated horizontal wooden element 22, which is affixed to top ends 23 of the parallel elements 19-21. Frame elements 19-21 all terminate in spaced relation from top 24, bottom 25, and side 26,27 edges of the base sheet 14. Frame elements 19,20 comprise outer frame elements, and frame element 21 is positioned therebetween. Spaces 28,29 leading to the base sheet 14 that are not covered by the frame 17 are defined by the frame elements 19-22.

In order to form a door unit 30, a moisture-barrier layer is also affixed to a rear face of a door sheet 33, which can comprise substantially the same material as that used for the base sheet 14. The door sheet 33 has a region wherein an aperture 34 is desired to be formed therein extending vertically from a bottom edge 31 to a height 36 below a top edge 37, and extending to a width 38 horizontally in spaced relation from opposed side edges 39,39′. A three-piece door jamb 13 is affixed to a front face 41 of the door sheet 33 in surrounding relation to the door sheet aperture region 34 at side 35,35′ and top 32 edges thereof (block 103).

In order to form a window unit 42, a moisture-barrier layer is also affixed to a rear face of a window sheet 45, which can comprise substantially the same material as that used for the base sheet 14. The window sheet 45 has a region wherein an aperture 46 is desired to be formed therein having opposed side edges 47,48, a bottom edge 49, and a top edge 50 in spaced relation from opposed side edges 51,52, a bottom edge 53, and a top edge 54 of the window sheet 45.

A frame 55 is affixed to a front face 56 of the window sheet 45. Side 57,58 and top 59 elements of the frame 55 are in spaced relation from the respective side 51,52 and top 54 edges of the window sheet 45. The frame 55 comprises a plurality of elongated frame elements that are affixed together. Two of the frame elements 57,58 positioned vertically closest to the respective side edges 51,52 of the window sheet 45 comprise outer frame elements. The top frame element 59 is adjacent and in spaced relation from the aperture region's top edge 50, and a central frame element 63 extends vertically from adjacent the aperture region's bottom edge 49 downward to adjacent the window sheet's bottom edge 53, leaving spaces 64,65 between the central frame element 63 and the outer frame elements 57,58.

A window jamb 66 is affixed to the window sheet's front face 56 in surrounding relation to the window sheet's aperture region 46 (block 104) at the side 47,48, the top 50, and the bottom 49 edges thereof, so that and a top jamb element 67 is positioned adjacent the top frame element 59, two side jamb elements 68,69 are positioned adjacent the respective outer frame elements 57,58, and a bottom jamb element 70 is positioned adjacent a top end 71 of the central frame element 63.

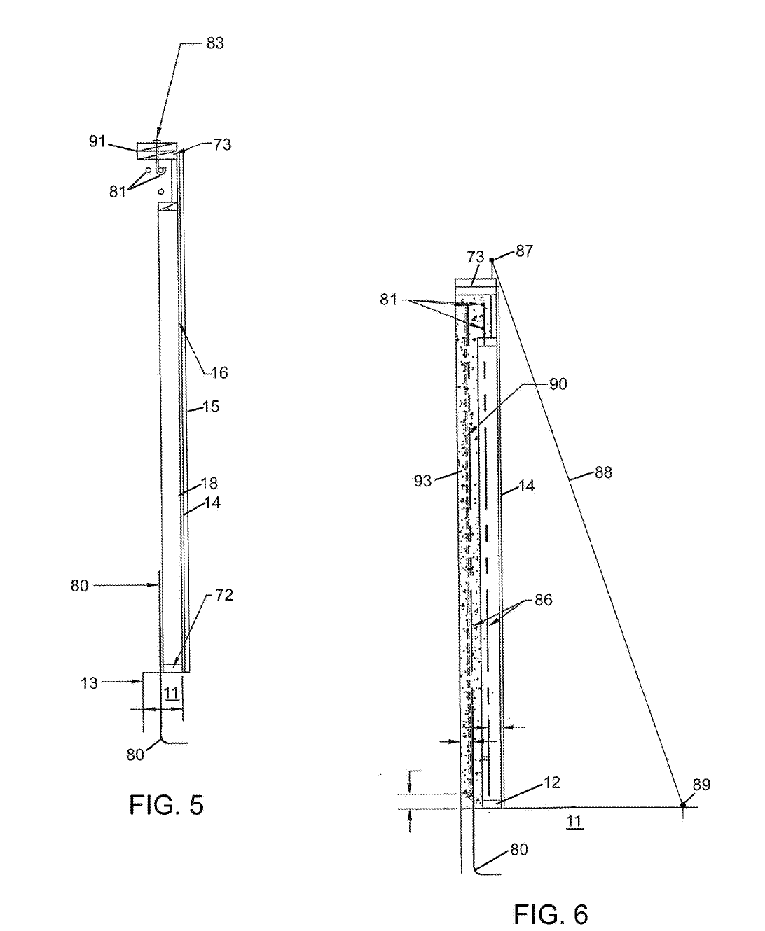

An elongated bottom support element 72 is affixed to the bottom edges 25,53 of the base 14 and window 45 sheets, respectively (block 105). An elongated top support element 73 is affixed to the top edges 24,37,54 of the base sheet 14, door sheet 33, and window sheet 45 (block 106). Preferably the top support element 73 extends horizontally farther than a horizontal extent of the frame elements relative to the base, door, and window sheets' front faces (see FIG. 5).

Insulation material 74 is affixed to the base sheet's front face 18 and to the window sheet's front face 56 in filling relation to the spaces 28,29; 64,65 defined by the frame elements (block 107). Additional insulation material 95 can also be positioned between the top support element 73 and the sheet's top frame element 22.

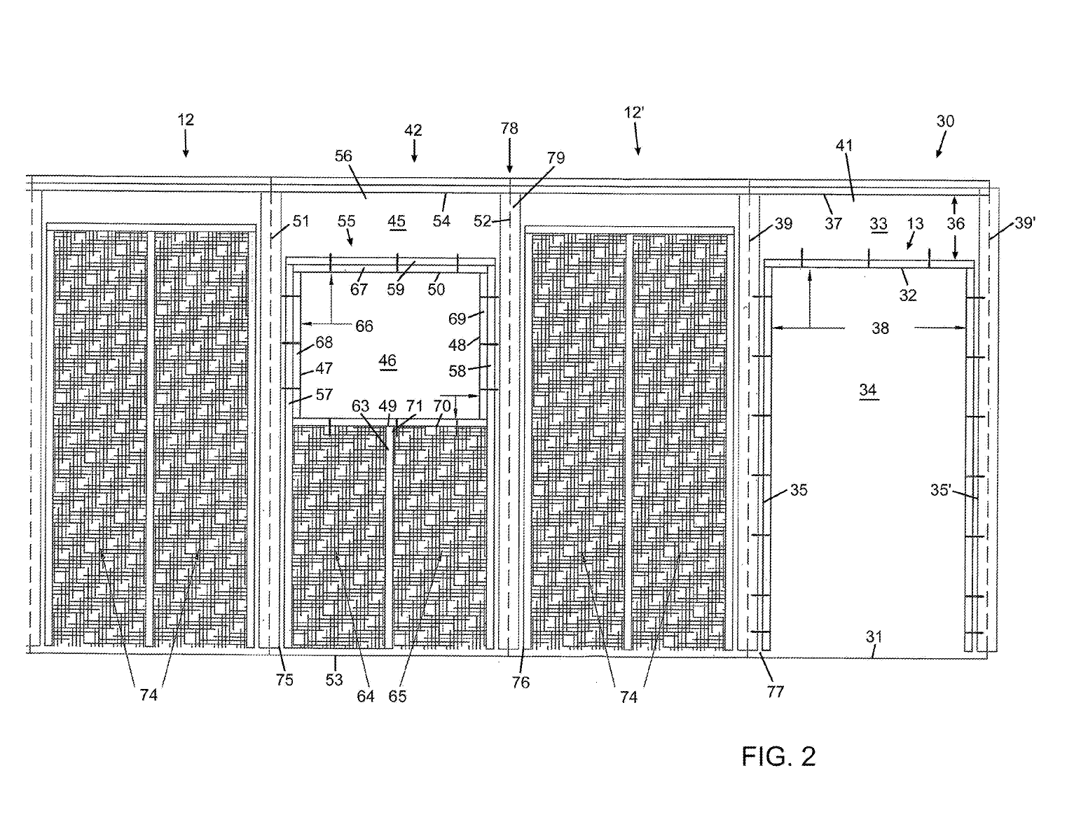

Structural wall 12,12′, door 30, and window 42 units can be positioned adjacent each other in substantially co-planar fashion as desired (FIG. 2; block 108). In this case, adjacent outer frame elements 20,19 of the first 12 and the second 12′ wall unit define a columnar space 75 therebetween. Similarly columnar spaces 76,77 are defined by door and window units, or any combination thereof. This positioning creates a joint 78 between adjacent outer edges 27,26, which is buttressed with a beam 79 placed and affixed therealong.

The bottom support element 72 is affixed to the foundation slab 11 at the building site (block 109). A dowel 80, for example, an “L”- or “J”-shaped bar, is inserted into the foundation slab 11 to extend substantially vertically within the columnar spaces 75-77 (FIGS. 5 and 6; block 110).

One or more horizontal top 81 and one or more horizontal bottom 82 reinforcing bars are positioned in front of and across the base sheet 14, door sheet 33, and window sheet 45 (block 111). The horizontal top reinforcing bar 81 is positioned beneath and adjacent the top support element 73, and the horizontal bottom reinforcing bar 82 is positioned above and adjacent the bottom support element 72. The horizontal top reinforcing bar 81 can be affixed to the top support element 73 with the use of a “J” bolt 83 (FIG. 5; block 112), although this is not intended as a limitation.

One or more additional reinforcing bars 84 can also be positioned in front of and across the door sheet 33 beneath the horizontal top reinforcing bar 81 and above the door aperture's top edge 37 (block 113). One or more additional reinforcing bars 85 can also be positioned in front of and across the window sheet 45 beneath the horizontal top reinforcing bar 81 and above the window aperture's top edge 50 (block 114).

One or more vertical reinforcing bars 86 are also positioned within the columnar spaces 75-77 (block 115), and a reinforcing bar 94 can also be positioned horizontally approximately midway along the door 14 and window 45 sheets.

During construction, in order to provide additional bracing for the structural units 12,12′,30,42, a top end 87 of an elongated brace member 88 can be affixed to the top support element 73. A bottom end 89 of the elongated brace member 88 can be affixed to the foundation slab 11 behind the rear face 16 of and in spaced relation from the structural units 12,12′,30,42 (block 116). This brace member 88 can comprise, for example, a wire, and should be sufficiently taut to retain the structural units 12,12′,30,42 in an upright orientation.

A substantially planar wire mesh 90 is positioned atop the structural units 12,12′,30,42 wherever there is no aperture 34,46 (block 117). The mesh 90 is positioned in horizontal spaced relation from the frame elements and the insulation material 74, and from a front edge 91 of the top support element 73 (see FIG. 5).

A sprayable concrete 93, for example, Gunite, is applied to the front faces of the structural units 12,12′,30,42 (block 118) so as cover the frames, the sheets' front faces, the insulation material, the bottom support element, the top support element, the reinforcing bars, and the dowel, and to fill the columnar spaces to form vertical columns, avoiding the aperture regions. The aperture regions are subsequently cut out (block 119).

When the concrete 93 has dried, the brace 88 and the door and window coverings 92 can be removed (block 120).

Exemplary dimensions for the elements of the system 10 will now be presented, with the understanding that these dimensions are not intended as limitations, and that local building codes and other site considerations may alter the specific relative and absolute dimensions.

The base sheet 14 can comprise 4 ft×8 ft×½-in. exterior plywood; the Visqueen 15 can be 2 mils thick. The base sheet frame 17 can be 85 in. high, 42 in. wide. The vertical frame elements 19-21 can comprise 2×4-in. pressure-treated wood, are 20.25 in. apart, 85 in. long, and are 1.5 in. above the base sheet's bottom edge 25. The top frame element 22 can comprise a 2×4-in pressure-treated plate, be 42 in. long, and is 9.5 in. below the top support element 73. The top support element 73 can comprise two 2×8-in. pressure-treated plates, fastened to the rebar 81 with a “J” bolt 83 and flat washer (FIG. 5).

The joint-protective beam 79 can comprise 1×4-in. pressure-treated board. The window 66 and door 13 jambs comprise 2×8-in. pressure-treated beams. The insulation material 74 can comprise, for example, 3½-in.-thick solid polyurethane, although this is not intended as a limitation.

The reinforcing bars 81,82,84,85,86,94 can comprise a #4 steel rebar. The horizontal rebars 81,82,94 are preferably separated by a maximum of 4 ft. The wire mesh 90 can comprise 4×4-in.-W4/W4 welded wire fabric positioned at a mid-depth of the concrete 93. The columns defined by the columnar spaces 75-77 are preferably a minimum of 6 in. wide and 6.25 in. deep, and encase two #4 steel rebars 86. The bottom support element 72 is attached to a plate that is affixed to the slab 11 using ¼×4-in. tapcons.

The exterior concrete 93 can comprise an air-injected shotcrete or Gunnite, such as used in the construction of swimming pools, is applied at 4500 psi, which cures much more rapidly than conventional concrete.

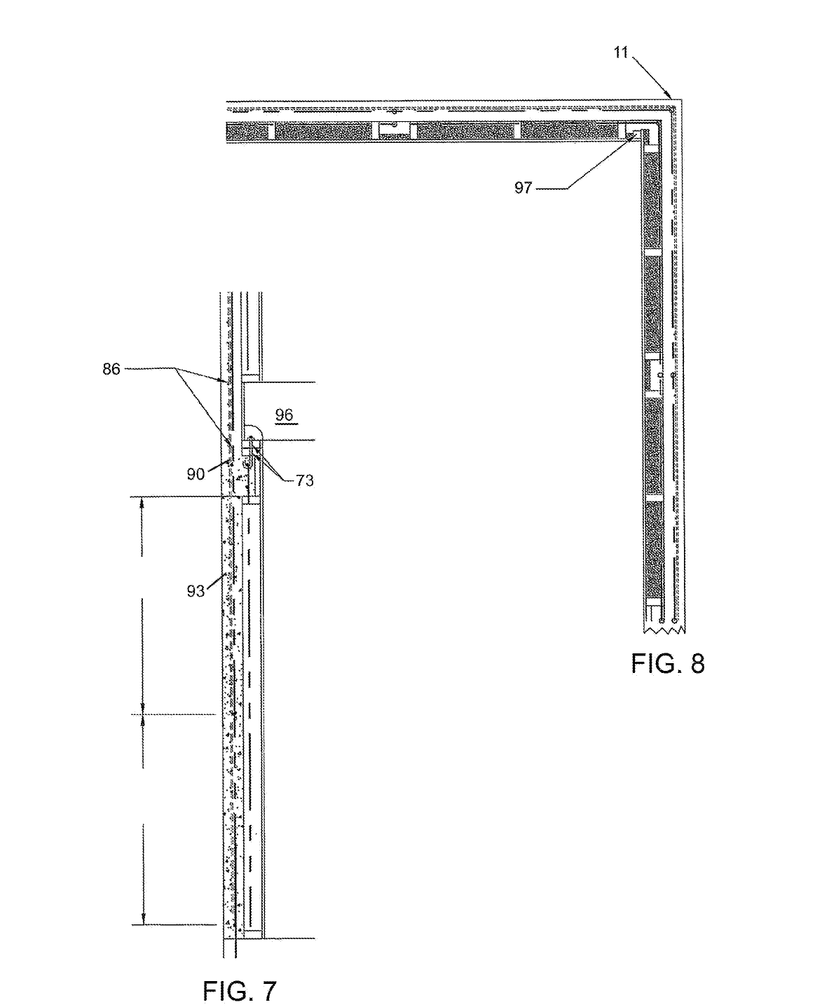

A second storey 96 (FIG. 7) can be added, wherein the vertical rebar 86 is extended upward, and the wire mesh 90 is extended 2 ft above the floor 96. Here only two smaller top plates 73, 2×4-in., are used.

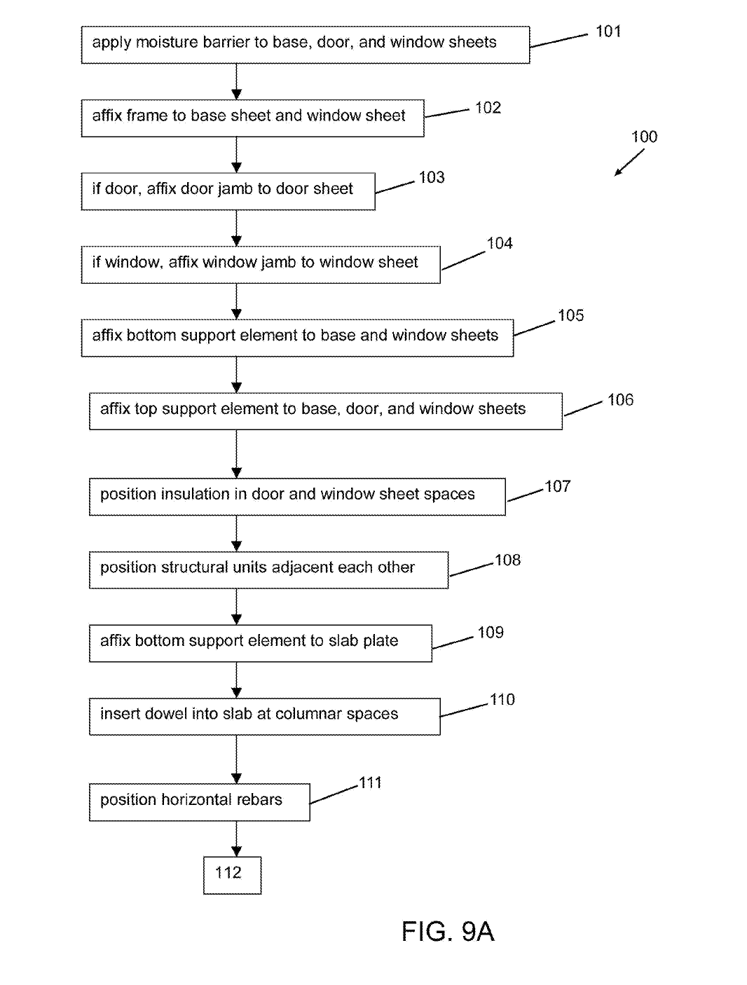

Corner construction (FIG. 8) can include a 2×2-in. pressure-treated corner tie 97.

The environmentally friendly wall structure 10 of the present invention has an R factor of 15.03, and can stand up to a category 4-5 hurricane. In addition, the concrete can be made into a firewall by adding fire clay into the concrete mix. Outside plumbing can be encased in the wall, thereby preventing freezing. Drywall can be added directly to the interior atop the plywood 14. Since the surface is solid concrete, there are no joints, thereby obviating air and moisture penetration. The columns and lintels are continuous and formed of concrete. The wall structure 10 can be assembled in a single day, using only a framing crew to assemble the framework. The interior walls are ready for drywall to be applied as desired for interior finishing.

In the foregoing description, certain terms have been used for brevity, clarity, and understanding, but no unnecessary limitations are to be implied therefrom beyond the requirements of the prior art, because such words are used for description purposes herein and are intended to be broadly construed. Moreover, the embodiments of the system and method illustrated and described herein are by way of example, and the scope of the invention is not limited to the exact details of construction and use.

Having now described the invention, the construction, the operation and use of preferred embodiments thereof, and the advantageous new and useful results obtained thereby, the new and useful constructions, and reasonable mechanical equivalents thereof obvious to those skilled in the art, are set forth in the appended claims.

What is claimed is:

1. A method for constructing an exterior wall of a building onsite comprising:
constructing a first and a second wall unit by, for each:
affixing a moisture-barrier layer to a rear face of a substantially planar base sheet of structural material;
affixing a frame to a front face of the base sheet, edges of the frame in spaced relation from respective opposed edges of the base sheet, the frame comprising a plurality of elongated frame elements affixed together and having spaces therebetween, two of the frame elements positioned vertically closest to respective side edges of the base sheet comprising outer frame elements;
affixing a bottom support element adjacent a bottom edge of the base sheet; and
affixing insulation material to the base sheet front face in filling relation to the spaces defined by the frame elements;
positioning the first and the second wall unit adjacent each other in substantially co-planar fashion, adjacent outer frame elements of the first and the second wall unit defining a columnar space therebetween;
affixing the first and the second wall bottom support elements to a foundation slab at a building site;
affixing a dowel in the foundation slab to extend substantially vertically within the columnar space; and
applying a sprayable concrete to the two wall units front faces so as cover the frame, the base sheet front face, the insulation material, the bottom support element, and the dowel, and to fill the columnar space to form a vertical column.

2. The method recited in claim 1, wherein the base sheet comprises a sheet of plywood.

3. The method recited in claim 1, wherein the frame elements comprise wood beams.

4. The method recited in claim 3, wherein the frame elements comprise four beams, a top beam extending substantially horizontally, and three substantially parallel, spaced-apart beams extending vertically, the three vertical beams comprising the outer frame elements and a central frame element positioned between the outer frame elements, the three beams affixed adjacent top ends thereof to the top beam.

5. The method recited in claim 1, further comprising affixing a top support element adjacent a top edge of the base sheets of the first and the second wall unit.

6. The method recited in claim 5, further comprising positioning a horizontal top and a horizontal bottom reinforcing bar in front of and across the base sheets of the first and the second wall unit, the horizontal top reinforcing bar beneath and adjacent the top support element and the horizontal bottom reinforcing bar above and adjacent the bottom support element.

7. The method recited in claim 6, further comprising affixing the top support element to the horizontal top reinforcing bar.

8. The method recited in claim 6, further comprising positioning a vertical reinforcing bar within the columnar space.

9. The method recited in claim 8, wherein the sprayable-concrete-applying step further comprises covering the horizontal top, the horizontal bottom, and the vertical reinforcing bars with the sprayable concrete.

10. The method recited in claim 5, wherein the top support element extends horizontally farther than a horizontal extent of the frame elements relative to the base sheet outer face, and further comprising positioning a substantially planar wire mesh atop the first and the second wall unit base sheets, in horizontal spaced relation from the frame elements and the insulation material, and from a front edge of the top support element.

11. The method recited in claim 5, further comprising, following the top-support-element affixing step:
affixing a top end of an elongated brace member to the top support element;
affixing a bottom end of the elongated brace member to the foundation slab behind the rear face of and in spaced relation from the first and the second wall unit;
the elongated brace member sufficiently taut to retain the first and the second wall unit in an upright orientation.

12. The method recited in claim 1, further comprising affixing a beam to the first and the second wall units along a joint formed by adjacent outer edges thereof.

13. The method recited in claim 1, further comprising constructing a door unit for the exterior wall comprising:
affixing a moisture-barrier layer to a rear face of a substantially planar door sheet of structural material;
affixing a door jamb to a front face of the door sheet in surrounding relation to a region of the door sheet wherein an aperture is desired;
affixing a bottom support element adjacent a bottom edge of the door sheet between the side edges of the door sheet and the side edges of the aperture region;
positioning the door unit adjacent the second wall unit in substantially co-planar fashion, an outer frame element of the second wall unit adjacent to a door jamb side edge defining a second columnar space therebetween;
affixing the door bottom support elements to the foundation slab;
applying a sprayable concrete to the door unit front face so as cover the door sheet front face outside the jamb, and to fill the second columnar space to form a vertical column; and
cutting around the aperture region to form the door aperture.

14. The method recited in claim 13, further comprising affixing a top support element adjacent a top edge of the base sheets of the first and the second wall units and adjacent the top edge of the door sheet.

15. The method recited in claim 14, further comprising positioning a first horizontal top reinforcing bar in front of and across the door sheet and the base sheets of the first and the second wall units, the first horizontal top reinforcing bar beneath and adjacent the top support element, and positioning a second reinforcing bar in front of and across the door sheet beneath the first horizontal reinforcing bar and above the door aperture top edge.

16. The method recited in claim 1, further comprising constructing a window unit for the exterior wall comprising:
affixing a moisture-barrier layer to a rear face of a substantially planar window sheet of structural material;
affixing a frame to a front face of the window sheet, side and top edges of the frame in spaced relation from the respective side and top edges of the window sheet, the frame comprising a plurality of elongated frame elements affixed together and having spaces therebetween, two of the frame elements positioned vertically closest to the respective side edges of the window sheet comprising outer frame elements, a top frame element adjacent and in spaced relation from a top edge of a region of the window sheet wherein an aperture is desired, and a central frame element extending vertically from adjacent a bottom edge of the aperture region downward to adjacent the window sheet bottom edge, leaving spaces between the central frame element and the outer frame elements;
affixing a window jamb to the window sheet front face in surrounding relation to the window sheet aperture region at side, the top, and the bottom edges thereof, and a top jamb element adjacent the top frame element, two side jamb elements adjacent the respective outer frame elements, a bottom frame element adjacent a top end of the central frame element;
affixing insulation material to the window sheet front face in filling relation to the spaces;
affixing a bottom support element adjacent the window sheet bottom edge;
positioning the window unit adjacent the second wall unit in substantially co-planar fashion, an outer frame element of the second wall unit adjacent a window side frame element defining a third columnar space therebetween;
affixing the window bottom support element to the foundation slab;
applying a sprayable concrete to the window unit front face so as cover the window sheet front face outside the window jamb, and to fill the third columnar space to form a vertical column; and
cutting around the window aperture region to form the window aperture.

17. The method recited in claim 16, further comprising affixing a top support element adjacent a top edge of the base sheets of the first and the second wall units and adjacent the top edge of the window sheet.

18. The method recited in claim 17, further comprising positioning a first horizontal top reinforcing bar in front of and across the window sheet and the base sheets of the first and the second wall units, the first horizontal top reinforcing bar beneath and adjacent the top support element, and positioning a second reinforcing bar in front of and across the window sheet beneath the first horizontal reinforcing bar and above the window aperture top edge.

19. A wall unit constructed using the method of claim 1.

20. An exterior wall of a building constructed at a site comprising a first and a second wall unit affixed to a foundation slab at a building site adjacent each other in substantially co-planar fashion, each comprising:
a substantially planar base sheet of structural material;
a moisture-barrier layer affixed to a rear face of the base sheet;
a frame affixed to a front face of the base sheet, edges of the frame in spaced relation from respective opposed edges of the base sheet, the frame comprising a plurality of elongated frame elements affixed together and having spaces therebetween, two of the frame elements positioned vertically closest to respective side edges of the base sheet comprising outer frame elements, adjacent outer frame elements of the first and the second wall unit define a columnar space therebetween;
a dowel affixed in the foundation slab extending substantially vertically within the columnar space;
a bottom support element affixed adjacent a bottom edge of the base sheet;
insulation material affixed to the base sheet front face in filling relation to the spaces defined by the frame elements; and
a sprayable concrete applied to the two wall units front faces in covering relation to the frame, the base sheet front face, the insulation material, the bottom support element, and the dowel, and to fill the columnar space to form a vertical column.

21. The wall recited in claim 20, wherein the base sheet comprises a sheet of plywood, and the frame elements comprise wood beams.

22. The wall recited in claim 21, wherein the frame elements comprise four beams, a top beam extending substantially horizontally, and three substantially parallel, spaced-apart beams extending vertically, the three vertical beams comprising the outer frame elements and a central frame element positioned between the outer frame elements, the three beams affixed adjacent top ends thereof to the top beam.

23. The wall recited in claim 20, further comprising a top support element affixed adjacent a top edge of the base sheets of the first and the second wall unit.

24. The wall recited in claim 23, further comprising a horizontal top and a horizontal bottom reinforcing bar positioned in front of and across the base sheets of the first and the second wall unit, the horizontal top reinforcing bar beneath and adjacent the top support element and the horizontal bottom reinforcing bar above and adjacent the bottom support element.

25. The wall recited in claim 24, wherein the top support element is affixed to the horizontal top reinforcing bar.

26. The wall recited in claim 24, further comprising a vertical reinforcing bar positioned within the columnar space.

27. The wall recited in claim 26, wherein the horizontal top, the horizontal bottom, and the vertical reinforcing bars are covered with the sprayable concrete.

28. The wall recited in claim 23, wherein the top support element extends horizontally farther than a horizontal extent of the frame elements relative to the base sheet outer face, and further comprising a substantially planar wire mesh positioned atop the first and the second wall unit base sheets, in horizontal spaced relation from the frame elements and the insulation material, and from a front edge of the top support element, the wire mesh covered with the sprayable concrete.

29. The wall recited in claim 20, further comprising a beam affixed to the first and the second wall units along a joint formed by adjacent outer edges thereof.

30. The wall recited in claim 20, further comprising a door unit affixed to the foundation slab adjacent the second wall unit in substantially co-planar fashion comprising:
a substantially planar door sheet of structural material;
a moisture-barrier layer affixed to a rear face of the door sheet
a door jamb affixed to a front face of the door sheet in surrounding relation to a region of the door sheet wherein an aperture is desired at side and top edges thereof, the outer frame element of the second wall unit adjacent to a door jamb side edge defining a second columnar space therebetween; and
a sprayable concrete applied to the door unit front face so as cover the door sheet front face outside the jamb, and to fill the second columnar space to form a vertical column.

31. The wall recited in claim 20, further comprising a window unit affixed adjacent the second wall unit to the foundation slab in substantially co-planar fashion comprising:
a substantially planar window sheet of structural material;
a moisture-barrier layer affixed to a rear face of the window sheet
a frame affixed to a front face of the window sheet, side and top edges of the frame in spaced relation from the respective side and top edges of the window sheet, the frame comprising a plurality of elongated frame elements affixed together and having spaces therebetween, two of the frame elements positioned vertically closest to the respective side edges of the window sheet comprising outer frame elements, a top frame element adjacent and in spaced relation from a top edge of the aperture region, and a central frame element extending vertically from adjacent a bottom edge of the aperture region downward to adjacent the window sheet bottom edge, leaving spaces between the central frame element and the outer frame elements, the outer frame element of the second wall unit adjacent a window side frame element defining a third columnar space therebetween;
a window jamb affixed to the window sheet front face in surrounding relation to the aperture region at side, the top, and the bottom edges thereof, and a top jamb element adjacent the top frame element, two side jamb elements adjacent the respective outer frame elements, a bottom frame element adjacent a top end of the central frame element;
insulation material affixed to the window sheet front face in filling relation to the spaces; and
a sprayable concrete applied to the window unit front face so as cover the window sheet front face outside the jamb, and to fill the third columnar space to form a vertical column.

32. A wall unit for use in forming an exterior wall of a building constructed at a site and affixable to a foundation slab at a building site comprising:
a substantially planar base sheet of structural material;
a moisture-barrier layer affixed to a rear face of the base sheet;
a frame affixed to a front face of the base sheet, edges of the frame in spaced relation from respective opposed edges of the base sheet, the frame comprising a plurality of elongated frame elements affixed together and having spaces therebetween, two of the frame elements positioned vertically closest to respective side edges of the base sheet comprising outer frame elements, a columnar space defined by each outer frame element and an adjacent outer frame of an adjacent second wall unit;
a dowel affixed in the foundation slab extending substantially vertically adjacent each outer frame element;
insulation material affixed to the base sheet front face in filling relation to the spaces defined by the frame elements; and
a sprayable concrete applied to the front face in covering relation to the frame, the base sheet front face, the insulation material, the bottom support element, and the dowel, and to fill the columnar space to form a vertical column.
